(19) United States
(12) Patent Application Publication
(10) Pub. No.: US 2013/0011724 A1
(43) Pub. Date: Jan. 10, 2013

(54) METHOD FOR PRODUCING BATTERY, AND BATTERY

(76) Inventor: Hiroyasu Kado, Toyota-shi (JP)

(21) Appl. No.: 13/636,173

(22) PCT Filed: Mar. 23, 2010
(86) PCT No.: PCT/JP2010/054983

§ 371 Date: Sep. 20, 2012

(51) Int. Cl. H01M 2/02; H01M 2/00

(52) U.S. Cl. 429/179; 29/623.1

(57) ABSTRACT

The electric terminal includes a press surface, which is formed as a flat surface extending from the outer circumferential section towards the inside, on the edge of the case in the direction in which the through hole extends. The electric terminal is inserted into the through hole with the insulating member therebetween, and the press surface of the electric terminal is pressed. As a consequence, a portion of the outer circumferential section of the electric terminal expands towards the inner circumferential surface side of the through hole, thereby forming an expanded portion. The electric terminal is secured to the through hole by means of the surface pressure applied by the expanded section. As a result, it is possible to provide a battery which exerts excellent sealing properties at the position in which the case and the electric terminal are secured.

### TECHNICAL FIELD

The present invention relates to a battery, especially to the battery including an electric terminal fixed to a case with penetrating therethrough and projecting therefrom, in which the sealing property at the fixed portion is improved.

### BACKGROUND ART

The case as a housing of the battery includes a box and a lid. The box contains an electrode body as a power generating element and has an opening to form a closed-end shape. The plate lid has a shape in accordance with the opening of the box to cover it.

The lid has a pair of through holes from which electric terminals are projected outward. The terminals work as the positive and negative electrode terminal for transmitting the electric power from the element.

The case is provided with a safety unit such as a relief valve penetrating therethrough in the thickness direction. For example, the relief valve works in the case that the defect such as a short circuit results in generation of large volume of gas, communicating the inside of the battery with the outside to prevent the internal pressure from increasing.

When the battery is a nonaqueous electrolyte secondary battery such as a lithium ion secondary battery, the contamination of water into the battery has an influence on the battery performance, so that the sealing property has to be secured. Furthermore, considering when the inner pressure raises caused by the inside defect, it is worth to seal the other portions to operate the safety unit securely.

Regarding the case of the battery, the box and lid are firmly fixed by welding or the like, so that in the fixed portion of the terminal into the lid, it is required to keep the fitting property of the terminal not to slip out from the lid, the sealing property for preventing from leaking the electrolytes contained in the case and gases generated in the battery, and the insulating property between the terminal and the case.

In the battery manufacturing process, particularly when fitting the terminal into the through hole formed in the lid, it is important to secure the sealing property of the fixed portion.

JP 2005-302625 A discloses a battery having an electric terminal projecting from a lid of the battery, in which an insulating member is arranged between the lid and terminal, and the lid is provided with a flanged portion standing out around the insulating member, enabled to keep the sealing property between the lid and the terminal by pressing the flanged portion from the direction parallel to the lid, that is perpendicular to the thickness direction of the lid.

Unfortunately, using the battery, a temperature cycle including heating and cooling is repeated, whereby the pressed portion is loosened to return the former shape and the sealing property is degraded.

[Patent Literature 1] JP 2005-302625 A

### SUMMARY OF INVENTION

### Technical Problem

The objective of the present invention is to provide an unexpected battery including a case and an electric terminal fixed to the case with projecting therefrom, provided with high sealing property at the fixed portion between the case and terminal.

### Technical Solution

The first aspect of the invention is a method of manufacturing a battery, which includes a case provided with a through hole; an electric terminal fixed to the through hole with projecting outward from the case, the electric terminal including a press surface formed as a flat surface at one end thereof; and an insulating member interposed between the case and the electric terminal. In the embodiment of the method as the first aspect, the electric terminal surrounded by the insulating member is inserted into the through hole and the press surface of the electric terminal is pressed to expand the outer portion of the electric terminal toward the inside of the through hole, whereby the electric terminal is fixed to the through hole.

Advantageously, the case is made of iron.

In the preferable embodiment, a flanged portion is formed around the through hole, standing out from the case.

The second aspect of the present invention is a battery, which includes a case provided with a through hole; an electric terminal fixed to the through hole with projecting outward from the case, the electric terminal comprising a press surface formed as a flat surface at one end thereof; an insulating member interposed between the case and the terminal, and with the terminal and the insulating member inserted in the through hole, the press surface of the electric terminal is pressed to expand the outer portion of the electric terminal toward the inside of the through hole, whereby the electric terminal is fixed to the through hole.

Advantageously, the case is made of iron.

In the preferable embodiment, the case includes a flanged portion around the through hole, standing out from the case.

### Advantageous Effects of Invention

According to the present invention, the battery is obtained that includes a case and an electric terminal fixed to the case with projecting therefrom, provided with high sealing property at the fixed portion between the case and terminal.

### BRIEF DESCRIPTION OF DRAWINGS

FIG. 1 depicts a battery according to the invention.

FIG. 2 depicts a lid of a case provided with through holes.

FIG. 3 illustrates an electric terminal.

FIG. 4 is an enlarged section view illustrating a fixing portion of the case and the electric terminal.

FIG. 5 shows a pressing method for fixing the electric terminal to the lid of the case, (a) illustrates the position relationship between those members, and (b) illustrates the state after pressing.

FIG. 6 depicts the alternative embodiment of the lid of the case.

FIG. 7 depicts the other embodiment of the lid of the case.

FIG. 8 shows the alternative embodiment of the pressing method.

FIG. 9 illustrates a battery module as the second embodiment of the battery.

FIG. 10 illustrates a battery pack as the third embodiment of the battery.

### REFERENCE SIGNS LIST

10: battery, 30: case, 32: lid, 33: through hole, 40: electric terminal, 43: press surface, 44: expanded portion, 50: insulating member

### DESCRIPTION OF EMBODIMENTS

### First Embodiment

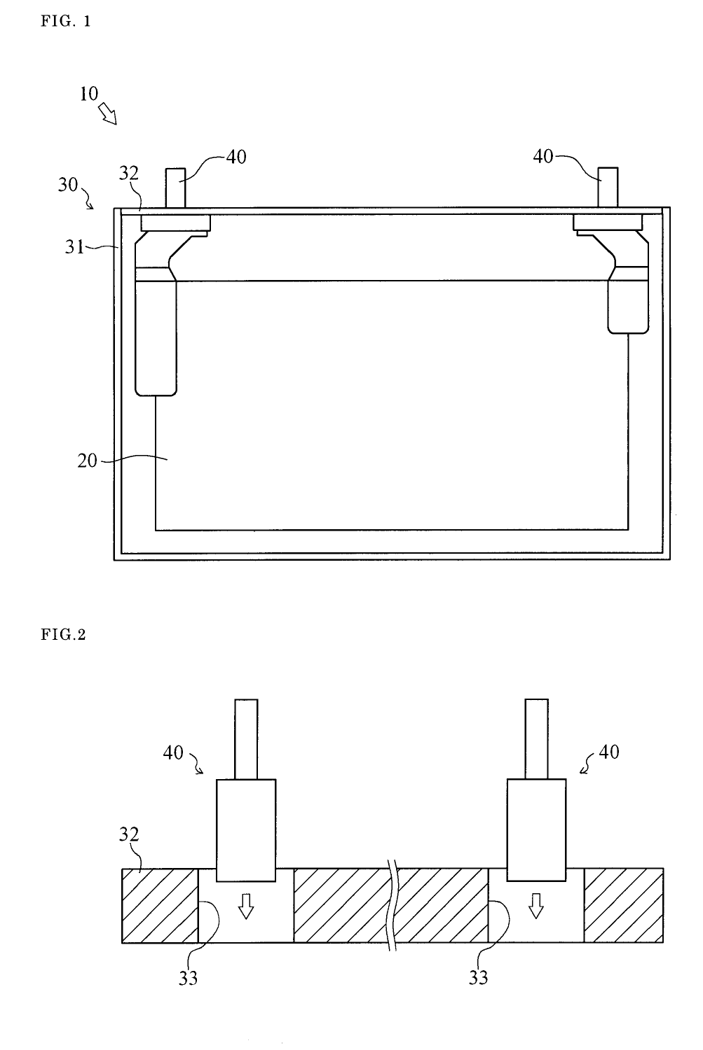

Referring to FIG. 1, the structure of a battery 10 as a first embodiment of the present invention is explained below.

The battery 10 is a single cell composed as a rechargeable secondary battery such as a lithium ion secondary battery, nickel-metal hydride battery or the like.

As shown in FIG. 1, the battery 10 includes a power generating element 20 contained in a case 30. The case 30 is penetrated by two electric terminals 40 projecting outward.

The element 20 is made of an electrode body with electrolyte impregnation, which is formed by laminating or winding a positive electrode, a negative electrode and a separator. When charging or discharging the battery 10, a chemical reaction is occurred in the element 20 (in detail, the ion moves between the positive and negative electrodes through the electrolytes), and thus the battery 10 works as the rechargeable secondary battery.

The case 30 includes a box 31 and a lid 32, and is made of iron (more specifically, nickel coated iron). The box 31 has a closed-end shape and an opening at one side, and contains the element 20. The lid 32 has a shape corresponding to the opening of the box 31, which covers the opening of the box 31 and is fixed to the box 31.

It should be noted that the materials of the box 31 and the lid 32 composing of the case 30 are not limited to the iron. In the embodiment, employing iron as the materials of the box 31 and the lid 32 from the viewpoint of strength, the materials such as aluminum which is used in the common batteries may be employed. Though, the metal having the strength (e.g. not less than 100 MPa) not less than that of iron is preferable.

The terminals 40 are configured as a positive terminal or a negative terminal, each of which is fitted into the case 30 projecting from the outer periphery of the case 30. For instance, the positive terminal 40 is made of aluminum and the negative terminal 40 is made of copper.

The terminals 40 are electrically connected to the positive electrode or negative electrode of the element 20 via suitable wires such as lead terminals, and the electrodes 40 transmit the electric power between the inside and outside of the battery 10. The terminals 40 are electric paths to the outside. The terminal 40 has a thread portion formed at the periphery, configured by thread rolling.

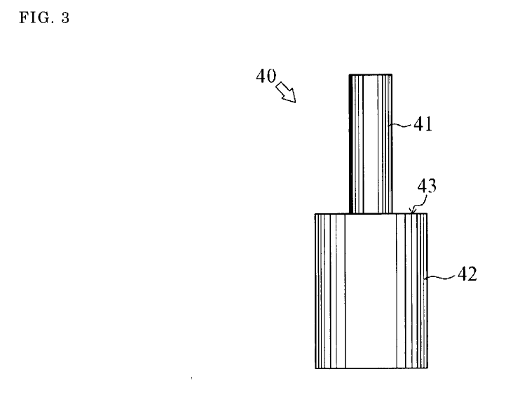

Referring to FIGS. 2 to 4, the fixing embodiment among the case 30 and the terminals 40 is explained in detail.

The terminals 40 are fixed to the lid 32 of the case 30 interposing insulating members 50 therebetween, which secure the insulating property between the terminals 40 and the case 30. When fixing the terminals 40, parts of the terminals 40 are pressed and the terminals 40 are compressed outward to fit the lid 32 and the insulating members 50 firmly. Thus, the sealing property between the lid 32 and the terminals 40 is secured.

As shown in FIG. 2, the lid 32 has a pair of through holes 33 through which the terminals 40 pass.

The holes 33 are drilled at predetermined diameters and penetrate the lid 32 in the thickness direction (in the vertical direction shown in drawings).

The terminal 40 is round terminals, and has a projecting portion 41 and a fixing portion 42.

The projecting portion 41 is a columnar portion of the terminal 40 (formed at the outer side end of the battery 10, that is the upper end in the drawings), which projects outward from the case 30. The projecting portion 41 is used to connect with the external equipment such as the power resource, the device using the electric power of the battery 10 and the other batteries. The connecting terminal of the external equipment is connected and fixed to the projecting portion 41. Because the projecting portion 41 works as the connector with the external devices, it has the thread portion at a part of the periphery or at the whole periphery.

The fixing portion 42 has a columnar shape formed continuously to the projecting portion 41 and projects toward the axial direction of the projecting portion 41. The outer diameter of the fixing portion 42 is larger than that of the projecting portion 41.

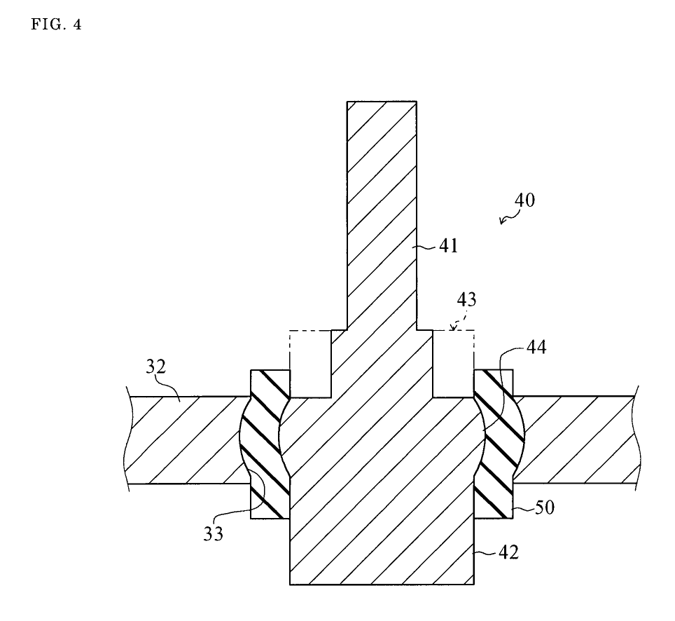

The outer diameter of the fixing portion 42 is set in accordance with the inner diameter of the insulating member 50. With the fixing portion 42 inserted into the insulating member 50, the electrode terminal 40 is fixed to the through hole 33 of the lid 32 (see FIG. 4).

The fixing portion 42 is formed at the other end of the terminal 40 (the end disposed at the inner side of the battery 10 and the lower end in the drawings). The fixing portion is fixed to the lid 32 and connected to the lead terminal of the power generating element 20. The axial length of the fixing portion 42 is larger than the thickness of the lid 32 and the axial length of the insulating member 50.

At the one end of the terminal 40 (the end inside of the battery 10, or the lower end in the drawings), or the connection portion between the projecting portion 41 and the fixing portion 42 where the diameter of the terminal changes, there is a press surface 43 having the desired width. The press surface 43 is a flat surface formed at the upper end of the fixing portion 42 and formed inward from the outside of the terminal 40. The press surface 43 is pressed with a pressing tool 60. The width of the press surface 43 is set such that the pressing area by the pressing tool 60 is sufficiently obtained.

The press surface 43 of the terminal 40 has the deformation area deformed during the pressing, and therefore the deformation area is not used for the electrical connection with the external equipment. If the terminal 40 is large, the width of the press surface 43 may be large, so that the non-pressed portion of the press surface 43 may be used as the seat for the nut when connecting with the external equipment.

As mentioned above, the terminal 40 has a stepped shape having the press surface 43 formed by the projecting portion 41 and the fixing portion 42. When fixing the terminal 40 to the through hole 33 of the lid 32, the outer side of the press surface 43 is pressed from outside of the battery 10 and thus the fixing portion 42 is plastic deformed and expanded outward (toward the insulating member 50), thereby fixing the terminal to the through hole.

As depicted in FIG. 4, between the through hole 33 of the lid 32 and the fixing portion 42 of the terminal 40, the insulating member 50 for insulating the case 30 with the terminal 40 is interposed.

The insulating member 50 is an insulator having the shape corresponding to the fixing portion 42, cylinder shape in the embodiment. The insulating member 50 wraps the fixing portion 42.

The axial length of the insulating member 50 is not shorter than that of the fixing portion 42. That is, the axial length of the insulating member 50 is set such that there exist the enough length to insulate the outside of the terminal 40 (particularly the fixing portion 42) with the inside of the lid 32 when the terminal 40 is fixed to the lid 32.

The insulating member 50 is preferably made of a material with high temperature creek characteristics, or with long-term creep resistance against the temperature cycle of the battery 10, for example, PEEK (poly (etheretherketone)).

The insulating member 50 also acts as the sealing member for securing the sealing property in the battery 10.

As shown in FIG. 4, the outer portion of the press surface 43 of the terminal 40 is press-fitted all over the periphery, or the material plastically moves in response to the pressing, from the outside of the battery 10 (upper side of the drawings).

Thus, an expanded portion 44 is formed such that the outer portion of the fixing portion 42 expands outward (more specifically, from the lower portion of the press surface 43 to be pressed). The expanded portion 44 is surrounded by the insulating member 50 which is made of softer material than the terminal 40, so that the expanded portion 44 expands toward the insulating member 50 (toward the inside of the through hole 33).

The expanded portion 44 expanded outside presses the insulating member 50, and the pressure is applied to the insulating member 50 as contact surface pressure. The portion in the insulating member 50 to which the contact surface pressure applied by the expanded portion 44 is elastically deformed outward, and the force in accordance with the elastic deformation is applied to the inside of the through hole 33 as contact surface pressure.

Thus, the press surface 43 of the terminal 40 is press-fitted from the upper side, forming the expanded portion 44 expanded outward, thereby the contact surface pressure is transmitted to the inside of the through hole 33 of the lid 32 via the insulating member 50. By the pressure, the lid 32 is pressed and the terminal 40 is fixed to the lid 32 of the case 30.

Due to the plastic deformation of the expanded portion 44 and the elastic deformation of the insulating member 50, there is no gap among the inside of the hole 33, the insulating member 50 and the fixing portion 42, occurring high bonding force therebetween. The sealing property between the lid 32 of the case 30 and terminal 40 is secured, thereby keeping the sealing property of the battery 10. The expanded portion 44 is press-fitted in the direction perpendicular to the expansion direction, so that the press-fitted portion does not return (loosen) according to the high contact surface pressure and friction force acting on the expanded portion, namely, the expanded portion is not easy to loosen.

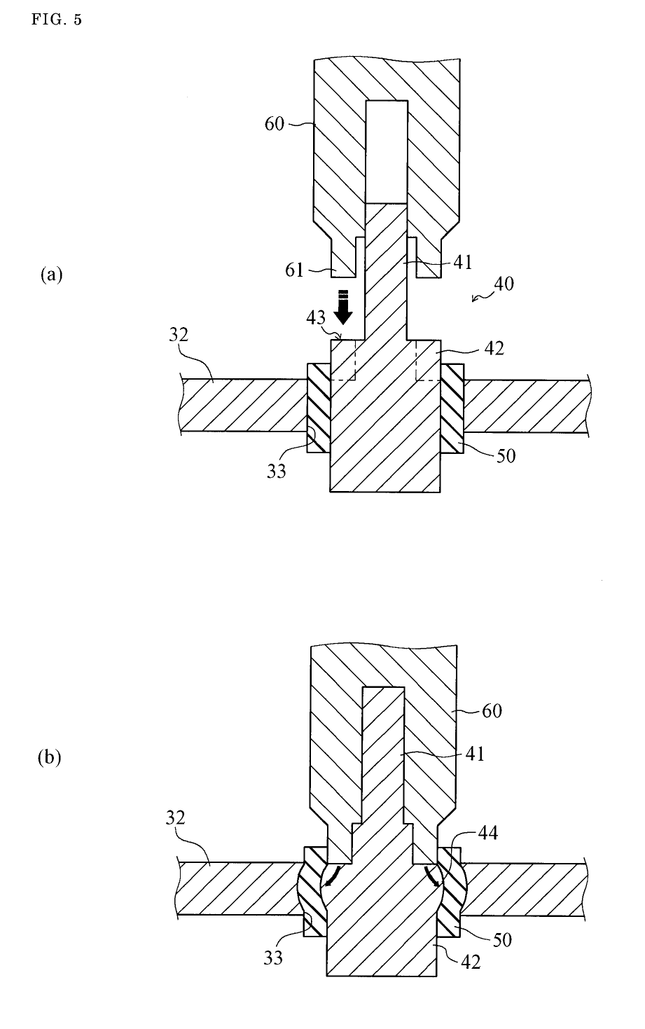

Referring to FIG. 5, the pressing embodiment where the terminal 40 is fixed to the lid 32.

As depicted in FIG. 5(a), the insulating member 50 is arranged at the outside of the fixing portion 42 of the terminal 40, and the terminal 40 and the insulating member 50 are inserted into the through hole 33.

The terminal 40 and the lid 32 are arranged such that the expanded portion 44 to be formed after pressing faces the inside of the hole 33.

As depicted in FIG. 5(b), using the pressing tool 60, the outer area of the press surface 43 of the terminal 40 is pressed by the predetermined amount from the outside of the battery 10, thereby forming the expanded portion 44 below the press surface 43 (inner side of the case 30). The expanded portion 44 expands toward the radially outwardly and therefore the surface pressure is occurred at the inside of the through hole 33 and insulating member 50. The surface pressure makes the terminal 40 and the insulating member 50 held and fixed to the lid 32.

The pressing tool 60 has a cylinder shape in which the part of the terminal 40 passes, and has a pressing blade 61 for pressing the press surface 43 provided at the end thereof. The pressing tool 60 is movable to approach/separate from the terminal 40 with a proper actuator.

During the pressing using the pressing tool 60, the proper jig is used to hold the lid 32, the terminal 40 and the insulating member 50.

The battery 10 includes the terminal 40 formed in stepped shape with the press surface 43 having the predetermined width, in which the press surface 43 is pressed from the outside and the area beneath the press surface 43 (pressed area) plastically moves outward, thereby forming the expanded portion 44. Thus, the sufficient surface pressure acts on the insulating member 50 surrounding the terminal 40 and the inside of the hole 33 disposed at the outside of the insulating member. Therefore, the terminal 40 and the insulating member 50 are solidly fixed in the hole 33, securing the bonding property therebetween. With respect to the battery 10 in which the terminal 40 projecting outward from the case 30 is fixed to the hole 33 of lid 32, the sealing property at the hole 33 as the fixing portion is improved.

Moreover, the expanded portion 44 is expanded outward, that is to expand the insulating member 50 and the lid 32 outwardly, thereby preventing the wrinkles at the insulating member 50 and the lid 32, and therefore the sealing property is maintained.

The lid 32 is made of iron that is high strength material, so that the high rigidity along the elongation direction of the lid 32 (the left-right direction in the drawings) is obtained.

Therefore, if the inner pressure rises, the battery 10 has resistance against the pressure acted on the lid 32 from the terminal 40 (around the through hole 33), so that the lifetime of the battery is improved.

In the embodiment, the through hole 33 is true circle, but the shape of the hole is not limited to that. For instance, the hole 33 may be shaped as an ellipse, rectangular, polygon or the like, in which the distance from the center of the hole to the inside is not even. In such structure, the expansion shape (viewed from the pressing direction) of the expanded portion 44 may be controlled to form the shape corresponding to the hole shape. In this case, the expanded portion 44 may be formed in the non-circular shape, thereby providing the terminal 40 with torque resistance and avoiding the defects caused by the rotation of the terminal 40 occurred during the connection with the outer equipment.

As the shape of the hole 33, the terminal 40 having stepped shape by the press surface 43 may be formed in non-circular shape, for example, forming the projecting portion 41 in circular shape and the fixing portion 42 in non-circular shape.

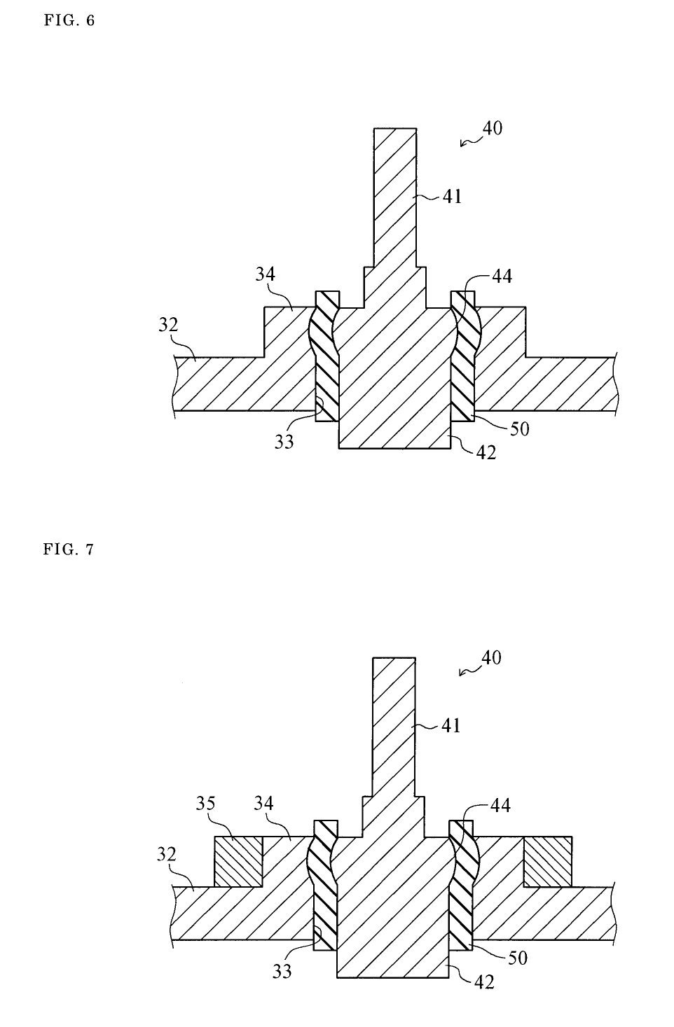

As depicted in FIG. 6, in the preferable alternative embodiment of the lid 32 of the case 30, the through hole 33 is formed with a flanged portion 34, thereby improving the rigidity around hole 33 of the lid 32.

The flanged portion 34 is formed at the edge of the hole 33 and stands out from the case 30 from inside to outside thereof (in the vertical direction shown in drawings). The flanged portion 34 is projected from the outer face of the lid 32, and defines the hole 33 at the inner wall thereof.

The part of the lid 32 (around the hole 33) is plastically deformed to form the flanged portion 34, which is formed by burring processing, deep drawing, damming, or the like. It should be noted that the lower end of the inside of the flanged portion 34 facing the hole 33 is formed in right angle, shown in FIG. 6, by die forming or the like.

Due to the flanged portion 34 formed around the hole 33 of the lid 32, the portion of the lid 32 around the terminal 40 may be increased, so that the holding force of the hole 33 for the terminal 40 is increased. The sealing property of the battery 10 is maintained when the vibration of the like occurs while using the battery 10, and therefore, the lifetime of the battery 10 can be improved.

Furthermore, as shown in FIG. 7, the flanged portion 34 projecting from the top of the lid 32 may be surrounded by a reinforcing ring 35.

The reinforcing ring 35 is a ring member formed in a shape corresponding to the flanged portion 34, made of metal having not less strength than the material of the lid 32. Arranging the reinforcing ring 35 at the periphery of the flanged portion 34, the thickness in the expanding direction of the expanded portion 44 at the side of lid 32 is increased and the flanged portion 34 is prevented from deforming outward, whereby the terminal 40 is held rigidly. As described above, the sealing property at the through hole 33 may be improved.

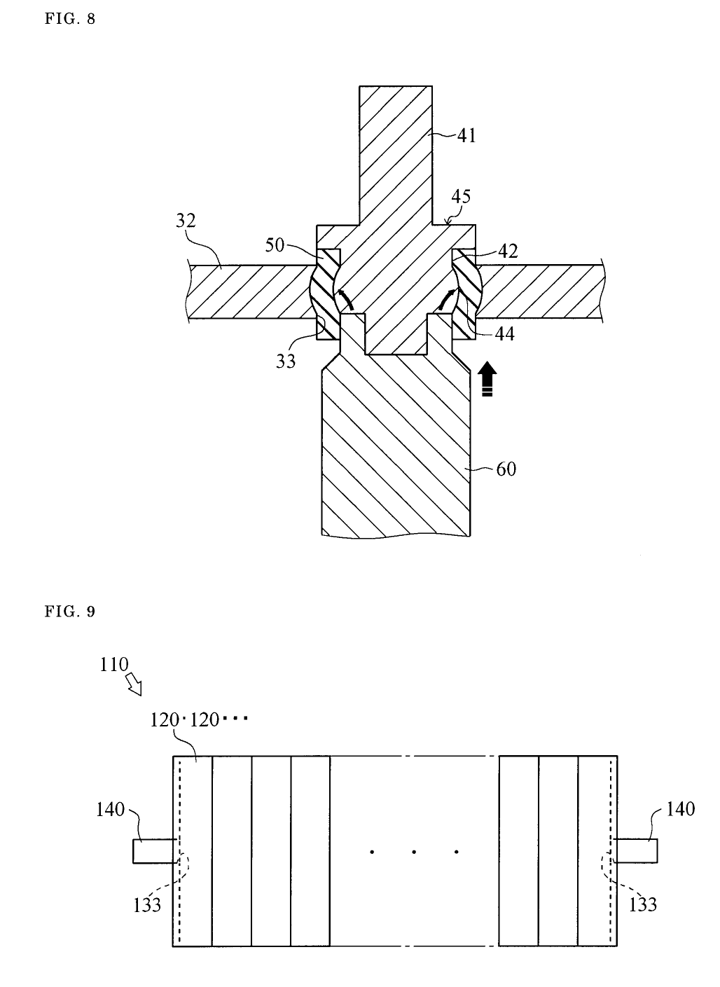

In the embodiment, the pressing direction to the terminal 40 is the direction from outside to inside of the battery 10, but, as shown in FIG. 8, the pressing may be operated from inside of the battery 10.

In this case, the projecting portion 41 of the terminal 40 may be continued to a seating surface 45 for connection to the external equipment, and thus the conductive area between the battery 10 and the external terminal is enlarged, thereby improving the conductive efficiency.

### Second Embodiment

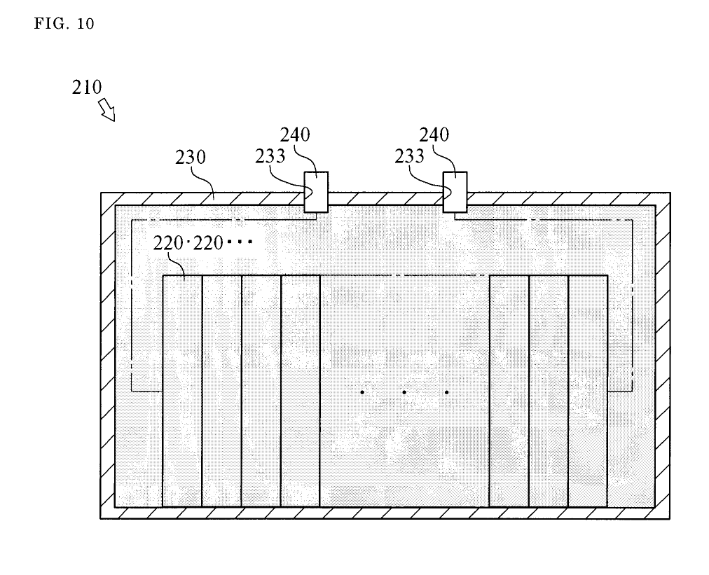

Referring to FIG. 9, a battery module 110 as a second embodiment of the invention will be described. The battery module 110 is an assembled battery composed of multiple batteries connected in series or in parallel.

As shown in FIG. 9, the battery module 110 includes multiple battery cells 120 and a pair of electric terminals 140.

The battery cells 120 are configured as a lithium ion secondary battery, nickel-metal hydride battery or the like, arranged contacting adjacently to each other and connected in series or in parallel. Each of the battery cells 120 is electrically connected in the case thereof, and the battery cells 120 that are disposed at both ends in the arrangement direction have the positive terminal 140 and the negative terminal 140 projecting outward.

The electric power is transmitted between inside and outside of the battery module 110 (or the battery cells 120) through the terminals 140.

The terminals 140 have the same structure as the electric terminals 40 in the first embodiment, including the press surfaces. Each terminal 140 is fixed to the through hole 133 formed at the case of the battery cell 120. The fixing method of the terminal 140 to the hole 133 may be performed as that of the first embodiment.

As the result, the battery module 110 obtains the same effects as the battery 10, thereby improving the sealing property at the holes 133 through which the electric terminals 140 pass.

### Third Embodiment

Referring to FIG. 10, a battery pack 210 as the third embodiment of the invention will be described. The battery pack 210 is an assembled battery housing multiple batteries connected in series or in parallel in a case.

As shown in FIG. 10, the battery 210 includes multiple battery cells 220, a case 230 housing the battery cells 220 and a pair of electric terminals 240.

The battery cells 220 configured as a lithium ion secondary battery, nickel-metal hydride battery or the like. Each of the battery cells 220 is electrically connected in the case 230.

The case 230 contains the battery cells 220, in which the cooling medium such as oil is filled. The terminals 240 are projected outward from the one side of the case 230.

The terminals 240 are electrically connected to the battery cells 220 via lead terminals.

The electric power is transmitted between inside and outside of the battery pack 210 (or the battery cells 220) through the terminals 240.

The terminals 240 have the same structure as the electric terminals 40 in the first embodiment, including the press surfaces. Each terminal 240 is fixed to the through hole 233 formed at the case 230. The fixing method of the terminal 240 to the hole 233 may be performed as that of the first embodiment.

As the result, the battery pack 210 obtains the same effects as the battery 10, thereby improving the sealing property at the holes 233 through which the electric terminals 240 pass.

As described in the first to third embodiments, in which the method for fixing the electric terminal to the case is employed, the terminals 40, 140 and 240 are pressed from the outside to inside of the batteries 10, 110 and 210, and plastically deformed outward (toward the inside of the through hole of the case), whereby the terminals are rigidly fixed to the holes, however, the fixing method is not limited to the battery. For instance, it is applicable to the case where the electrical terminals for taking out the electric power from the metal case are penetrated to the case, securing the sealing structure of the case and fixing the terminals rigidly.

### INDUSTRIAL APPLICABILITY

The present invention is applicable to a battery including a case and an electric terminal projecting from the case, particularly to the technique of securing sealing property in the through hole formed in the case through which the terminal penetrates.

1. A method of manufacturing a battery comprising: a case provided with a through hole; an electric terminal fixed to the through hole with projecting outward from the case, the electric terminal comprising a press surface formed as a flat surface at one end thereof; and an insulating member interposed between the case and the electric terminal, the method comprising:
inserting the electric terminal surrounded by the insulating member into the through hole;
pressing the press surface of the electric terminal to plastically move the pressed area of the electric terminal outward and to expand the outer portion of the electric terminal toward the inside of the through hole, whereby the electric terminal is fixed to the through hole.

2. The method according to claim 1, wherein the case is made of iron.

3. The method according to claim 1, further comprising:
forming a flanged portion around the through hole, standing out from the case.

4. A battery, comprising:
a case provided with a through hole;
an electric terminal fixed to the through hole with projecting outward from the case, the electric terminal comprising a press surface formed as a flat surface at one end thereof;
an insulating member interposed between the case and the terminal,
wherein with the terminal and the insulating member inserted in the through hole, the press surface of the electric terminal is pressed and the pressed area of the electric terminal is plastically moved outward to expand the outer portion of the electric terminal toward the inside of the through hole, whereby the electric terminal is fixed to the through hole.

5. The battery according to claim 4, wherein the case is made of iron.

6. The battery according to claim 4,
wherein the case comprises a flanged portion around the through hole, standing out from the case.
